(19) United States
(12) Patent Application Publication
(10) Pub. No.: US 2016/0114641 A1
(43) Pub. Date: Apr. 28, 2016

(54) VEHICLE LINK COMPONENT, AND MANUFACTURING METHOD THEREFOR

(71) Applicants: YOROZU CORPORATION, Kanagawa (JP); TORAY INDUSTRIES, INC., Tokyo (JP)

(72) Inventors: Shigeo IWASAWA, Tokyo (JP); Yoshito KURODA, Nagoya-shi (JP); Shuichiro KAWAGUCHI, Yokohama-shi (JP); Yoshihiro MORIWAKI, Yokohama-shi (JP); Shota TABATA, Yokohama-shi (JP)

(73) Assignees: TORAY INDUSTRIES, INC., Tokyo (JP); YOROZU CORPORATION, Yokohama-shi, Kanagawa (JP)

(21) Appl. No.: 14/894,458

(22) PCT Filed: May 28, 2013
(86) PCT No.: PCT/JP2013/064792

§ 371 Date: Nov. 27, 2015

(51) Int. Cl. B60G 7/00; B29C 65/48; B29C 65/00; B21D 53/88

(52) U.S. Cl. CPC B60G 7/001; B21D 53/88; B29C 65/48; B29C 66/7212; B29C 66/742; B60G 2200/1424; B60G 2206/122; B60G 2206/7101; B60G 2206/821; B60G 2206/8207; B29L 2031/3002

(57) ABSTRACT

The present invention comprises: a vehicle link component which is characterized in that a collar member is provided to a rotation fulcrum member-mounting hole section of a link body formed from carbon-fiber reinforced plastic (CFRP), said collar member having a cylindrical section that extends inside the hole section in the direction of penetration of the hole section, and having an engagement section that extends in the direction along the surface of the link body from the cylindrical section; and a manufacturing method therefor. By employing the CFRP link body, a significant reduction in the weight of the vehicle link component can be achieved, and assembly can easily be performed as desired without causing damage by press-fitting a bush, or the like, even in the CFRP link body.

### TECHNICAL FIELD OF THE INVENTION

The present invention relates to a vehicle link component and a manufacturing method therefor, and specifically, to a vehicle link component in which a link body is formed from a carbon-fiber reinforced plastic (CFRP), and a manufacturing method therefor.

### BACKGROUND ART OF THE INVENTION

A vehicle link component, for example, a suspension arm or the like, is frequently formed from a metal such as a steel or an aluminum alloy. In such a metal link component formed from a steel, an aluminum alloy, etc., in an attachment section provided to a link body for mounting a rotation fulcrum member such as a ball joint, a bush, etc., a standing-up surface is formed by carrying out burring processing onto the link body, and the rotation fulcrum member is mounted to a hole section surrounded by the standing-up surface portion by being press-fitted or the like to the hole section (for example, Patent documents 1 and 2).

Although CFRP has been used for reducing the weight of a vehicle compartment and for other purposes in recent years, because CFRP does not deform plastically, it is almost impossible to form a standing-up surface by burring processing. Even if a standing-up surface is formed in a link body at a molding stage by using a mold or the like, there occurs a possibility that a damage is caused in the link body if a bush or the like is press-fitted directly into the attachment section.

As another method, Patent document 2 proposes a method for forming a flange integrally with an outer surface of a case of a ball joint by machine processing without carrying out burring processing onto a link body, and welding the flange and the link body. However, because welding cannot be applied to a link body formed from CFRP, this method cannot be employed for a vehicle link component formed from CFRP.

### PRIOR ART DOCUMENTS

### Patent Documents

Patent document 1: Japanese Patent 4,264,933

Patent document 2: JP-A-HEI 6-156032

### SUMMARY OF THE INVENTION

### Problems to be Solved by the Invention

Accordingly, in consideration of the above-described circumstances, an object of the present invention is to, when employing a CFRP link body for weight reduction, etc., provide a vehicle link component capable of performing assembly without accompanying with the above-described press-fitting and welding, and a manufacturing method therefor.

### Means for Solving the Problems

To achieve the above-described object, a vehicle link component according to the present invention is characterized in that a collar member is provided to a rotation fulcrum member-mounting hole section of a link body formed from a carbon-fiber reinforced plastic (CFRP), the collar member having a cylindrical section which extends inside the hole section in a direction of penetration of the hole section, and an engagement section which extends in a direction along a surface of the link body from the cylindrical section. Where, although the link body is formed from CFRP, the material of the collar member is not particularly restricted, a metal such as a steel, an aluminum alloy, a plastic, etc. can be applied, and from the viewpoint of fixing strength to the link body, it is preferably formed from a metal. Further, the engagement section of the collar member may be formed together with the cylindrical section by machine processing, or may be formed by connecting it to the cylindrical section by welding, etc.

In such a vehicle link component according to the present invention, since a collar member is provided as a member different from a link body, it becomes possible to mount a rotation fulcrum member of the link body via the collar member. Then, since it becomes possible to mount the rotation fulcrum member to this collar member by press-fitting or the like in advance and to attach the collar member, having been press-fitted with the rotation fulcrum member, to the rotation fulcrum member-mounting hole section, a possibility causing a damage of the mounting section due to a press-fitting force in case where the rotation fulcrum member is press fitted directly to the CFRP link body can be removed. Further, since the collar member having a cylindrical section and an engagement section which extends in a direction along a surface of the link body is used, merely by inserting the cylindrical section of the collar member into the above-described hole section and bringing the engagement section of the collar member into contact with the surface of the link body, it becomes possible to easily mount and fix the collar member, having been press-fitted with the rotation fulcrum member, to the link body at a predetermined formation. Therefore, while it makes possible to reduce the weight of the link component by employing the CFRP link body, assembly to a predetermined formation becomes possible easily without causing an inconvenience.

Further, in the vehicle link component according to the present invention, it is preferred to employ a structure wherein an adhesive is interposed at least at a part of a portion between the above-described collar member and the above-described link body. In such a structure, by fixing via the adhesive, the collar member is fixed to the link body more securely. Where, the adhesive may be applied to a predetermined surface before insertion of the hole section of the collar member or before attachment of a nut, a retaining ring, etc. described later.

Further, in the vehicle link component according to the present invention, a structure can be employed wherein the above-described collar member has two engagement sections, and the collar member is fixed to the above-described hole section of the link body by nipping the link body with the two engagement sections. By nipping the link body from both sides thereof with the two engagement sections, the strength for fixing of the collar member relative to the link body can be increased, and ultimately, the connection strength between the link body and the rotation fulcrum member can be enhanced.

In this case, a structure can be employed wherein one of the above-described two engagement sections is a flange formed integrally with the above-described cylindrical section, and the other is a nut screwed to a thread cut on an outer circumferential surface of the cylindrical section. Alternatively, a structure can be employed wherein the above-described two engagement sections are both nuts screwed to a thread cut on an outer circumferential surface of the cylindrical section. In such structures, since the link body is nipped by the nut and the flange or by the two nuts via fastening of the nut or nuts, the strength for fixing of the collar member relative to the link body can be further increased, and ultimately, the connection strength between the link body and the rotation fulcrum member can be further enhanced.

Alternatively, a structure can be employed wherein one of the above-described two engagement sections is a flange formed integrally with the above-described cylindrical section, and the other is a retaining ring press-fitted to the cylindrical section so as to be press-contacted to one surface of the link body. In such a structure, since the machine processing for cutting a thread on an outer circumferential surface of the cylindrical section becomes unnecessary as compared with the above-described structures having the nut or nuts, the manufacture can be facilitated and becomes inexpensive, and it becomes a structure more suitable for mass production. In this case, a structure can be employed wherein the flange formed integrally with the above-described cylindrical section is formed in a trumpet shape extending from the cylindrical section by being enlarged in diameter, and at least a part of an inner circumferential surface of the above-described hole section is formed in a shape along an outer circumferential surface of the flange. The inner circumferential surface of the hole section may be formed in a curved-surface shape almost completely along a curved surface of the outer circumferential surface of the flange formed in a trumpet shape by being enlarged in diameter, or may be formed in a polygonal-line shape in section which is chamfered at a corner portion of the inner circumferential surface of the hole section.

Further, as the above-described rotation fulcrum member, typically a bush or a ball joint can be exemplified. However, other rotation fulcrum members can be used.

Further, as the vehicle link component according to the present invention, for example, a suspension arm can be raised. Although a link body of a suspension arm has been made from a metal as shown in the aforementioned Patent documents 1 and 2, by forming it from CFRP in the present invention, a remarkable reduction in weight becomes possible.

A method for manufacturing a vehicle link component according to the present invention is a method for manufacturing the above-described vehicle link component, and comprises the steps of: press-fitting a rotation fulcrum member into the collar member; applying an adhesive to at least a part of a portion between the collar member and the link body; inserting the collar member press-fitted with the rotation fulcrum member into a rotation fulcrum member-mounting hole of the link body; and fixing the inserted collar member to the link body using the engagement section.

In such a method, press-fitting or welding is not carried out relatively to the CFRP link body, and while a possibility of damage caused accompanying with press-fitting to the link body can be removed, a predetermined assembly can be performed easily. By employing the CFRP link body, a remarkable reduction in weight of a vehicle link component can be achieved.

### Effect According to the Invention

Thus, in the present invention, by employing a CFRP link body, a remarkable reduction in weight of a vehicle link component can be achieved, and even in case of the CFRP link body, a desired assembly can be easily performed without causing damage due to press-fitting of a bush or the like. Further, because it is an assembly interposing a collar member, incorporation of conventional various bushes or the like becomes possible, and it becomes possible to provide compatibility between respective parts in the assembly.

### BRIEF EXPLANATION OF THE DRAWINGS

FIG. 1 is a perspective view of a link body in a vehicle link component according to an embodiment of the present invention.

FIG. 2 is a perspective view of a collar member in a vehicle link component according to an embodiment of the present invention.

FIG. 3 is a sectional view showing an example of attachment state of the collar member depicted in FIG. 2.

FIG. 4 is a sectional view showing an example of attachment state of a collar member in a vehicle link component according to another embodiment of the present invention.

FIG. 5 is a sectional view showing another example of attachment state of a collar member similar to that depicted in FIG. 4.

FIG. 6 is a sectional view showing an example of attachment state of a collar member in a vehicle link component according to a further embodiment of the present invention.

FIG. 7 is a sectional view showing an example of attachment state of a collar member in a vehicle link component according to a still further embodiment of the present invention.

FIG. 8 is a sectional view showing an example of attachment state of a collar member in a vehicle link component according to a modification of that depicted in FIG. 7.

### EMBODIMENTS FOR CARRYING OUT THE INVENTION

Hereinafter, embodiments of the present invention will be explained referring to figures.

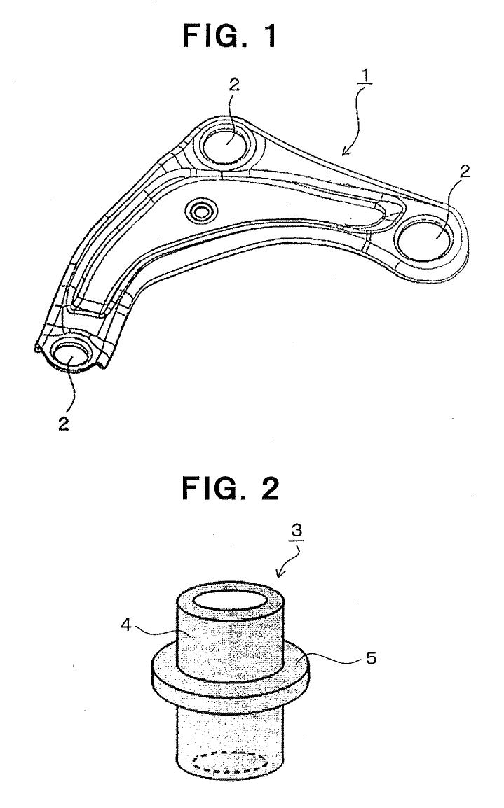

FIG. 1 shows a suspension arm 1 as a link body in a vehicle link component according to an embodiment of the present invention, and this suspension arm 1 is formed as a molded article of a carbon-fiber reinforced plastic (CFRP). The molding method of CFRP is not particularly restricted, and RTM (Resin Transfer Molding) method, so-called vacuum-assisted RTM method accompanying with pressure reduction in a mold, etc. can be applied. Further, the kind of carbon fibers used as reinforcing fibers also is not particularly restricted, and the content thereof also is not particularly restricted. Furthermore, the kind of a matrix resin also is not particularly restricted, and both thermoplastic resin and thermosetting resin can be used.

To the above-described suspension arm 1 as a link body, for its own rotation fulcrum, or, for a rotation fulcrum for connection between it and another member to be connected rotatably to each other, rotation fulcrum member-mounting holes 2 are provided. To at least one of these rotation fulcrum member-mounting holes 2, a collar member 3, for example, one as shown in FIG. 2, is disposed and inserted thereinto. Collar member 3 has a cylindrical section 4 which extends inside the hole 2 in a direction of penetration of the hole 2, and a flange 5 as an engagement section which extends in a direction along a surface of the suspension arm 1 from the cylindrical section 4. In the example shown in the figure, it is configured as a metal collar member 3 in which cylindrical section 4 and flange 5 are integrally formed by machine processing.

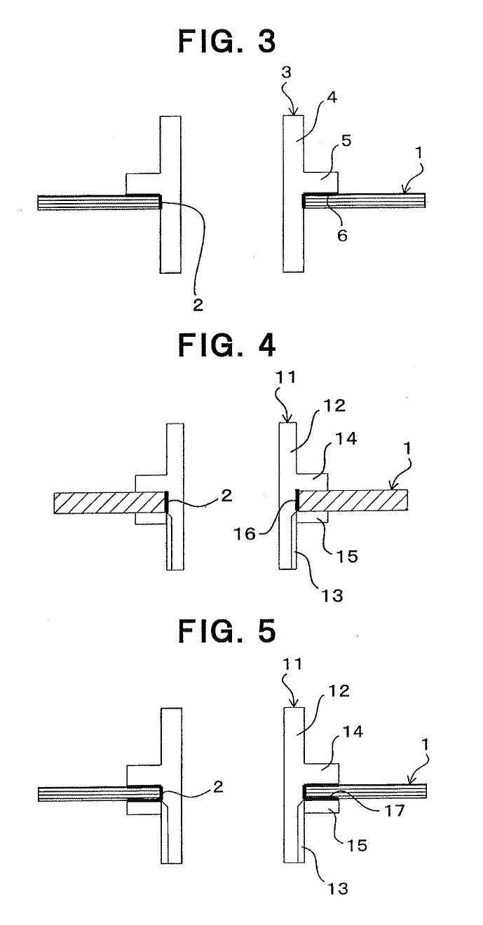

As shown in FIG. 3, collar member 3 formed as described above is attached to the section of hole 2 of suspension arm 1, and fixed thereto. In the embodiment shown in FIG. 3, cylindrical section 4 of collar member 3 is inserted into hole 2 of suspension arm 1, and flange 5 is brought into contact with the surface of the suspension arm 1 around the hole 2. An adhesive 6 is applied in advance to a predetermined portion of the outer surface of collar member 3, and at least at the portion at which flange 5 of the collar member 3 comes into contact with the surface of suspension arm 1, the collar member 3 is connected and fixed to the suspension arm 1 via the adhesive 6. Further, a rotation fulcrum member (not shown in the figure) such as a bush or a ball joint is inserted in advance into cylindrical section 4 of collar member 3 by press-fitting, etc., and fixed thereto, and at the state performed with the press-fitting, etc., the collar member 3 is inserted, connected and fixed relatively to suspension arm 1.

In the vehicle link component according to the present invention, a structure can be employed wherein the collar member has two engagement sections, and by nipping the suspension arm with the two engagement sections, the collar member is fixed to the hole section of the suspension arm more securely.

For example, as shown in FIG. 4, a structure can be employed wherein a thread 13 is cut on a part of the outer circumferential surface of a cylindrical section 12 of a collar member 11, suspension arm 1 is nipped with a flange 14 formed integrally with the cylindrical section 12 as one engagement section and a nut 15 screwed to the thread 13 as the other engagement section, and the collar member 11 is securely fixed to the section of hole 2 of the suspension arm 1. Also in this case, an adhesive 16 may be interposed at least between the outer circumferential surface of cylindrical section 12 of collar member 11 and the inner circumferential surface of hole 2 of suspension arm 1, thereby improving the strength for connection and fixing. Further, in this case, as shown in FIG. 5, the coating area of an adhesive 17 can be increased. In an example shown in FIG. 5, the adhesive 17 is applied in advance to a portion at which nut 15 comes into contact with the surface of suspension arm 1, and at the state where the nut 15 is fastened, the nut 15 is also connected and fixed to the suspension arm 1 via the adhesive 17.

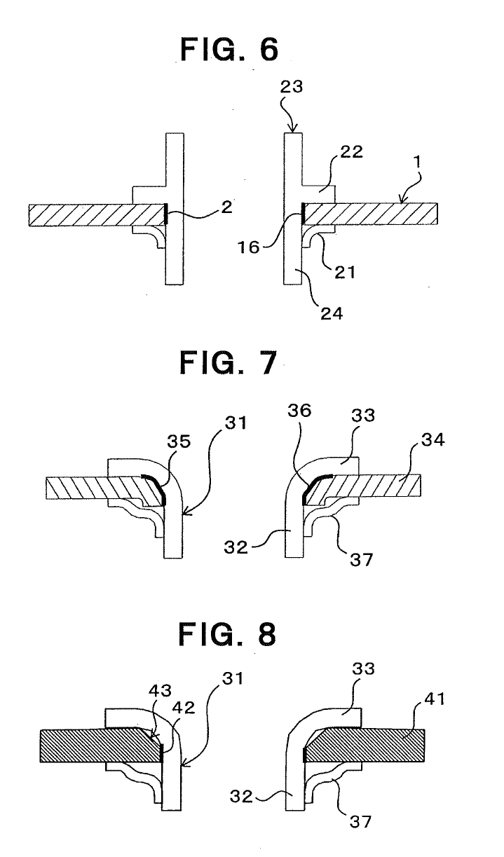

Further, for example, as shown in FIG. 6, instead of the above-described nut 15 as the other engagement section, a structure using a retaining ring 21 may be employed. In such a structure, as compared with the structure shown in FIG. 4, it is not necessary to perform machine processing for cutting a thread on the outer circumferential surface of a cylindrical section 24 of a collar member 23 having a flange 22 similarly to that described above, thereby facilitating the processing and the manufacture.

Further, for example, as shown in FIG. 7, a structure can be employed wherein a flange 33 formed integrally with a cylindrical section 32 of a collar member 31 is formed in a trumpet shape extending from the cylindrical section 32 by being enlarged in diameter, and at least a part of an inner circumferential surface of a section of a hole 35 of a suspension arm 34 is formed in a curved surface shape along an outer circumferential surface of the flange 33. In such a structure, an adhesive 36 can be interposed in a broad range between the inner circumferential surface of the section of hole 35 and the outer circumferential surface of flange 33, and it becomes possible to further improve the strength of connection and fixing. Also in this case, a retaining ring 37 similar to that shown in FIG. 6 may be used.

Further, for example, as shown in FIG. 8 as a modification of FIG. 7, the inner circumferential surface of a section of a hole 42 of a suspension arm 41 is not formed in a curved surface shape almost completely along the curved surface of the outer circumferential surface of the flange 33 as shown in FIG. 7, but it can also be formed in a polygonal-line shape in section (chamfered portion 43) which is chamfered at a corner portion of an inner circumferential surface of the section of the hole 42. In such a structure, the processing or the molding of the inner circumferential surface of the section of hole 42 can be facilitated, and it becomes possible to achieve a structure more suitable for mass production.

Thus, although the vehicle link component according to the present invention can employ various embodiments, when explained referring to the embodiment shown in FIG. 3, since collar member 3 having flange as another member different from the body of CFRP suspension arm 1 is provided to the section of rotation fulcrum member-mounting hole 2, it becomes possible to mount a rotation fulcrum member via this collar member 3. Since it becomes possible to mount a rotation fulcrum member to this collar member 3 in advance by press-fitting, etc., and to attach the collar member 3 press-fitted with the rotation fulcrum member to the rotation fulcrum member-mounting hole 2 section, a possibility for causing damage of the attachment portion due to a force of press-fitting when the rotation fulcrum member is press-fitted directly to CFRP suspension arm 1 can be removed. By this, it becomes possible to employ CFRP suspension arm 1 practically.

With respect to collar member 3 playing such a role, merely by inserting cylindrical section 4 thereof into the section of hole 2 and bringing flange 5 thereof into contact with the surface of suspension arm 1 preferably via adhesive 6, it becomes possible to easily attach and fix the collar member 3 press-fitted with the rotation fulcrum member to the suspension arm 1 at a desired formation. Alternatively, by further adding nut 15 as an engagement section and fastening it as shown in FIG. 4 or FIG. 5, preferably by fastening the nut 15 so as to be brought into contact with the surface of suspension arm 1 via an adhesive, it becomes possible to easily attach and fix the collar member 11 press-fitted with the rotation fulcrum member securely to the suspension arm 1 at a desired formation. Furthermore, as shown in FIGS. 6 to 8, by using retaining ring 21, 37 as the engagement section instead of the nut, because it becomes unnecessary to perform thread processing to the cylindrical section of the collar member, the processing and the manufacture can be facilitated, and it becomes possible to achieve an inexpensive structure more suitable for mass production. Even in any embodiment, while reduction in weight of the whole of the vehicle link component can be achieved by employing a CFRP suspension arm, assembly easily to a desired formation becomes possible.

### INDUSTRIAL APPLICABILITY

The present invention can be applied to any vehicle link component having a CFRP link body.

### EXPLANATION OF SYMBOLS

1, 34, 41: suspension arm as link body
2, 35, 42: rotation fulcrum member-mounting hole
3, 11, 23, 31: collar member
4, 12, 24, 32: cylindrical section
5, 14, 22, 33: flange as engagement section
6, 16, 17, 36: adhesive
13: thread
15: nut as engagement section
21, 37: retaining ring as engagement section
43: chamfered portion

1. A vehicle link component characterized in that a collar member is provided to a rotation fulcrum member-mounting hole section of a link body formed from a carbon-fiber reinforced plastic, said collar member having a cylindrical section which extends inside said hole section in a direction of penetration of said hole section, and an engagement section which extends in a direction along a surface of said link body from said cylindrical section.

2. The vehicle link component according to claim 1, wherein said collar member is formed from a metal.

3. The vehicle link component according to claim 1, wherein an adhesive is interposed at least at a part of a portion between said collar member and said link body.

4. The vehicle link component according to claim 1, wherein said collar member has two engagement sections, and said collar member is fixed to said hole section of said link body by nipping said link body with said two engagement sections.

5. The vehicle link component according to claim 4, wherein one of said two engagement sections is a flange formed integrally with said cylindrical section, and the other is a nut screwed to a thread cut on an outer circumferential surface of said cylindrical section.

6. The vehicle link component according to claim 4, wherein said two engagement sections are both nuts screwed to a thread cut on an outer circumferential surface of said cylindrical section.

7. The vehicle link component according to claim 4, wherein one of said two engagement sections is a flange formed integrally with said cylindrical section, and the other is a retaining ring press-fitted to said cylindrical section so as to be press-contacted to one surface of said link body.

8. The vehicle link component according to claim 7, wherein said flange is formed in a trumpet shape extending from said cylindrical section by being enlarged in diameter, and at least a part of an inner circumferential surface of said hole section is formed in a shape along an outer circumferential surface of said flange.

9. The vehicle link component according to claim 1, wherein said rotation fulcrum member comprises a bush or a ball joint.

10. The vehicle link component according to claim 1, wherein said vehicle link component is a suspension arm.

11. A method for manufacturing a vehicle link component according to claim 1, comprising the steps of:
press-fitting a rotation fulcrum member into said collar member;
applying an adhesive to at least a part of a portion between said collar member and said link body;
inserting said collar member press-fitted with said rotation fulcrum member into a rotation fulcrum member-mounting hole of said link body; and
fixing said inserted collar member to said link body using said engagement section.
